(19) United States
(12) Patent Application Publication
(10) Pub. No.: US 2011/0115845 A1
(43) Pub. Date: May 19, 2011

(54) INK JET PRINT HEAD WITH AUTOMATED CLEANING AT THE START OF PRINTING

(76) Inventor: Hervé Gregoire, Chateauneuf Sur Isere (FR)

(21) Appl. No.: 12/743,526

(22) PCT Filed: Nov. 28, 2008
(86) PCT No.: PCT/EP08/66390

§ 371 Date: May 18, 2010

Related U.S. Application Data
(60) Provisional application No. 61/097,347, filed on Sep. 16, 2008.

(30) Foreign Application Priority Data
Nov. 29, 2007 (FR) 07 59421

(51) Int. Cl. B41J 2/165

(52) U.S. Cl. 347/30

(57) ABSTRACT

Liquid jet (3) print head (T) comprising:
a generator (1) of drops of liquid, the lower part of which comprises a plate (2) equipped with at least one nozzle (4) for ejecting the liquid,
a sorting block (5) laid out below the nozzle plate (2) and offset in relation to the axis (Z) of the nozzle; wherein the block and the generator are fixed in relation to each other by delimiting a first space (9) and by forming an angle α in a vertical plane (YZ),
means (50, 51) to suck up any stagnant liquid (13) in the first space and/or in the angle before the ejection of liquid via the nozzle at the start up of printing.

### TECHNICAL FIELD

The invention concerns the field of printing by jet or drops of liquid, such as ink.

It relates to making the start up of a liquid jet printer reliable during the phase of formation of the jets of said liquid.

It more particularly concerns the cleaning, before the start of printing, of any stagnant liquid near to the orifice(s) through which the liquid, such as ink, is ejected.

A preferred application field is ink jet printing.

### STATE OF THE PRIOR ART

The fundamental principle of an ink jet printer is to force the passage of liquid (generally ink) through calibrated orifices.

An individual or collective actuator to the nozzles pressurises the ink upstream of the nozzle. The ink is ejected with a velocity of several metres to several tens of metres per second depending on the printing technologies. The passage of the ink to the free surface (getting through the nozzle) creates an air vacuum zone in the immediate vicinity of the drop or the jet of ink depending on whether “drop on demand” or “continuous jet” type printing technology is involved. For printers based on drop on demand technology, the ink is projected through a nozzle plate generally clear of any wall downstream of the nozzle plate, wherein said latter plate is a simple flat surface. The draught created by the projection of the drops does not generate or generates little air vortex or vacuum capable of carrying along micro-droplets or deflecting the drops with as consequence dirtying, polluting, of the nozzle plate. In continuous jet technologies, the family of the deflected continuous jet is not subjected to this problem of soiling of the nozzle plate or of elements downstream of the nozzle plate since they are generally at a distance of several hundreds of microns from the jets.

In binary continuous jet technology, the aerodynamic effects are particularly pronounced due to the multitude of jets (formation of a jet curtain) and the confinement of drop sorting electrodes as near as possible to the nozzle plate and the curtain of jets. During the transitory phase of start up of the jet curtain, a strong vacuum is created at the intersection of the planes formed by the surface of the nozzle plate and the surface of the block supporting the drop deflection electrodes. Any liquid (ink, solvent, cleaning liquid) present in this zone is pushed towards the jets. When there is contact, the jets are deflected, the direction of deflection of the jets is deterministic. The jets are definitely deflected towards the block of electrodes, which is literally washed: the problem to be resolved is not to soil the functional elements downstream (below) the nozzle plate during the formation phase of the curtain of jets.

Conventionally, this problem is circumvented by freeing the electrode block from the nozzle plate during the start up phase of the jets (see for example U.S. Pat. No. 5,808,642). The jets being formed, the block of electrodes is a moving part that approaches or moves away from the jets depending on whether the printer is available for printing or in start up/maintenance phase.

The binary continuous jet such as implemented by the Versamark Company is faced with the same problem. Since the block electrode is fixed, the problem of start up turns out to be more crucial and is treated indirectly by means of a maintenance device based on the concept whose commercial denomination is “eyelid” and which is protected notably by U.S. Pat. No. 6,247,781. According to this “eyelid” concept, the print head, totally sealed during the cleaning phase, is equipped with a maintenance circuit that is complex, costly and demanding in terms of functionalities. This maintenance circuit is disclosed in U.S. Pat. No. 7,055,931.

Nevertheless, the zone near to the jets situated immediately downstream of the nozzle plate is a sensitive zone of the print head in which impurities capable of short circuiting the electrodes of the block can accumulate. One improved solution for cleaning this zone has therefore been proposed in U.S. Pat. No. 7,178,897.

The principal drawbacks of the prior art described above are therefore numerous and may be classed by category and enumerated as follows:

1) For devices using a moving system of electrode(s) at the start of printing:
the stroke of the actuator used to achieve the displacement of the block of electrodes is considerable and its positioning must be very precise,
the guiding is complex and moreover is in an environment where the liquid is always likely to dry and thereby block the required displacements of the moving electrode(s),
the cost of producing said moving system is high,
the size of said moving system is considerable.

2) For devices using a system of fixed electrodes:
no specific action, aimed at resolving the problem of deflection of the jets at start up by the stagnant liquid, is provided for,
the necessity of cleaning or maintaining the cleanliness of the sensitive zone by means of a maintenance device subsists at each start up,
this cleaning solution is costly and necessitates long operations.

### DESCRIPTION OF THE INVENTION

The invention proposes, among other advantages, making up for the drawbacks of existing print heads and, in a general manner, avoiding any soiling of the sorting block caused by a deflected ink jet, at the start of printing, by the stagnant liquid near to the place of ejection of the ink.

To this end, the invention relates to a liquid jet print head comprising:
a generator of drops of liquid, the lower part of which comprises a plate equipped with at least one nozzle for ejecting the liquid,
a sorting block laid out below the nozzle plate and offset in relation to the axis of the nozzle; wherein the sorting block and the generator are fixed in relation to each other by delimiting a first space and by forming an angle in a vertical plane,
means for sucking up any stagnant liquid in the first space and/or in the angle before the ejection of liquid from the nozzle at the start of printing, in which the suction means comprise at least one groove cut on the face of the block opposite the nozzle plate while being opened towards said plate, wherein a zone of the groove is placed at atmospheric pressure and another zone is placed at a lower pressure so as to thereby suck up any stagnant liquid towards the lower pressure zone during the start up of printing.

Compared to existing techniques, the invention resolves the problem of forming and maintaining the jet (or the curtain of jets) by specifically treating one cause of non reliability (or failure) at the start of printing. Moreover, any liquid likely to stagnate near to the place of ejection after the start up may also be sucked up according to the invention, which thereby prevents any soiling of the sorting block.

The block or sorting system according to the invention is a selective deflection device for the ink emitted by the nozzle to place the printed drops and the recycled ink (not printed) on separate trajectories. In other words, the sorting block is a device that introduces different trajectories for different drops of liquid or portions of jet. Thus, the sorting block may comprise a device comprising at least one electrode exercising an electrostatic action on one or several jet(s) of liquid. By way of example, the sorting system may be a block of electrode(s) (case of binary ink jet technology, etc.). The sorting system may also be a block equipped with blowing means, such as those present in print heads according to air flow technology.

According to a first embodiment of the invention, one end of the groove opens out at the end of the block at atmospheric pressure and the suction means comprise a suction pump linked to another zone of the groove, wherein bringing the pump into operation at the start of printing sucks up any stagnant liquid.

According to another advantageous embodiment, the block of electrode(s) comprises a liquid recovery gutter laid out at least in part below the electrode(s) while delimiting a second space and, the suction means comprise:
at least one channel, forming a chimney, cut in the block and opening out on either side onto the first and second spaces,
the groove cut on the face of the block, one end of which opens out at the end of the block, at atmospheric pressure, and in which a zone communicates with the chimney, wherein the start up of the print head causes a suction in the second space in such a way that any stagnant liquid in the first space is sucked up in the groove then pushed into the chimney by a forced vacuum to be collected and evacuated via the gutter.

According to an advantageous alternative, the block is matched with a bevel in the vertical plane between the first and the second space, wherein the chimney is cut as near as possible to the bevel in order to reduce the communication length between the chimney and the groove.

According to another advantageous alternative, the groove is cut at a distance from the edge of the block such that the straight section of the groove is greater than the straight section delimited by the height of the first space and said distance between the edge of the block and the groove.

In embodiments where the print head comprises a multitude of nozzles aligned enabling a curtain of jets to be generated, the electrodes are identical for all of the curtain of jets and the chimney is positioned above one end of the electrode (Elec).

Preferably, the block of electrode(s) comprises at least one groove machined on a face adapted to be fixed below a nozzle(s) plate of said head.

The advantages of the invention are numerous:
the block of electrodes, known as SORTING block, may remain integral with the drop generator or jet generator and it is therefore not necessary to implement a releasing movement of the sorting block (moving system of electrodes according to the prior art), in particular during the formation of the jet curtain,
the sorting block and the drop generator may be assembled without sealing constraint, always difficult to achieve since the sealing means must not degrade the ejection quality of the nozzles, in other words must not interfere with the flow around the nozzle,
the suction means of the liquid according to the invention specifically dry a liquid retention zone, which simplifies the maintenance of the head and offers an excellent jet start up reliability,
the suction means of the liquid according to the embodiment by grooving and vacuum chimney are perfectly integrated in a print head without there being any necessity for additional components and avoiding size constraints inherent in any additional component,
the cost of the suction function according to the invention is low for a maximum efficiency.

### BRIEF DESCRIPTION OF DRAWINGS

Other characteristics and advantages of the invention will become clear on reading the description provided hereafter and by referring to the appended figures, given solely by way of illustration and in no way limiting. Among these drawings:

FIG. 1 is a schematic general view of a print head T according to the invention,

FIGS. 2A and 2B are schematic side views showing the phase of start up of a print head according to the prior art,

FIG. 3 is a schematic view in cross section showing the start up phase of a print head according to the invention,

FIG. 4 is a top view of an embodiment of the print head according to the invention,

FIG. 5 is a schematic view also in cross section of a print head according to the invention,

FIG. 6 is a detail view in cross section of a print head according to the invention.

### DETAILED DESCRIPTION OF SPECIFIC EMBODIMENTS

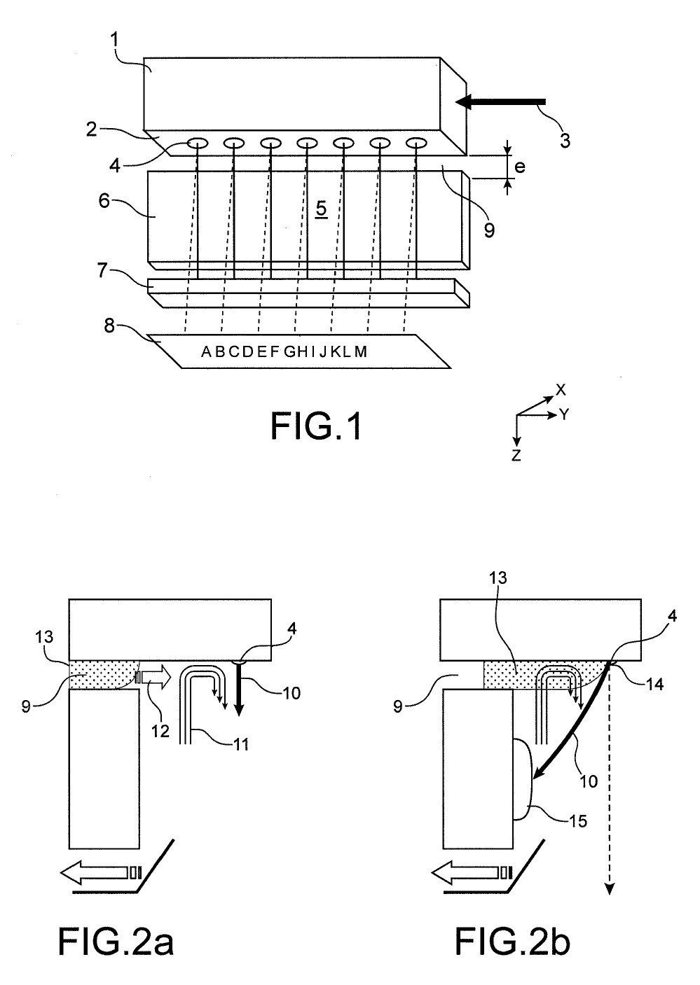

A print head T according to the invention comprises a drop generator 1 equipped with a nozzle plate 2. In printing phase, the ink 3 pressurised in the generator 1 flows out via the nozzles 4 to form a jet curtain. Downstream of the nozzle plate 2, along the flow direction of the ink (along the Z axis) is located a sorting block 5 comprising a functional electrodes part 6. The function of this electrodes part 6 is to place on different trajectories portions of jet, a quantity of which is collected by the recycling gutter 7 whereas the other is directed towards the media to be printed 8 (FIG. 1).

The terms “lower” and “upper” should be understood with the print head oriented downwards (flow direction of the jets along z), in other words with the above generator 1 in part directly above the block of electrodes 5 according to the invention.

Between the nozzle plate 2 and the sorting block 5, there exists, by construction, a space 9 whose thickness can be reduced to a simple interface if the two elements 2, 5 are in contact. Typically in continuous jet print heads, this space 9 is around 0.1 mm.

According to the prior art, during the maintenance phase of the print head or even in operation, liquid is trapped in the space 9. The more the surface tension attracts and maintains the liquid in this interstice of low dimensions, the more the entrapment is efficient. It may also be that the entrapment takes place at the angle (right angle in the embodiment illustrated) formed between the plate 2 and the block 5.

According to the prior art, the formation of jets 10, for example in the start up phase, carries along the surrounding air creating a vortex 11 delimited by the vertical surface of the sorting block 5 along the Z axis, the nozzle plate 2 and the jet curtain 10. The air brought into movement creates a vacuum symbolised by the arrow 12, vacuum which is capable of attracting the stagnant liquid 13 in the air space 9 (FIG. 2a). This stagnant liquid 13 comes into contact 14 with the jets 10, which are inevitably deflected towards the sorting block 5 (FIG. 2b). The pollution thereby created, symbolised by the cluster 15, adversely affects the correct operation of the sorting block 5 since the apparent surface of the electrode(s) that act on the conductive liquid is fouled up.

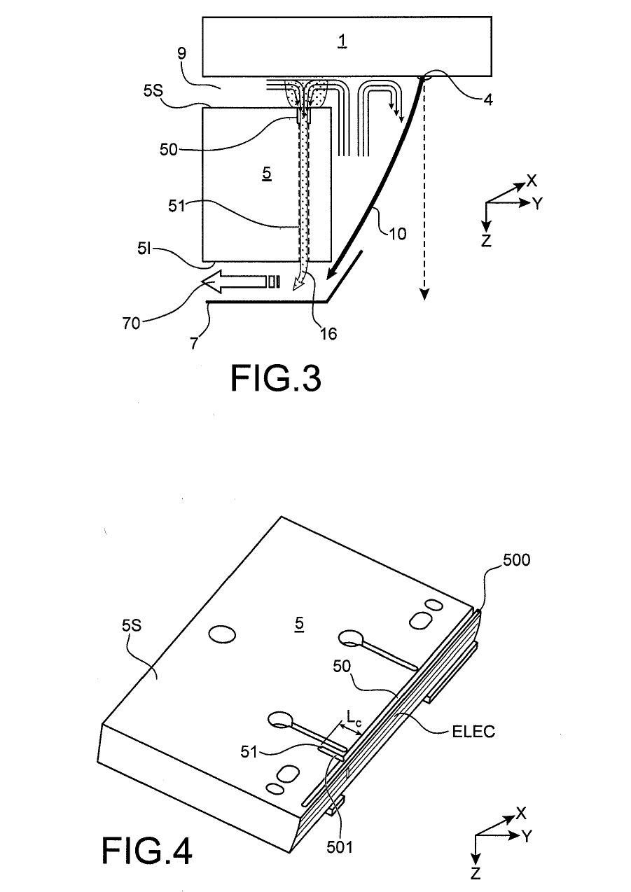

To overcome this drawback, firstly, according to the illustrated embodiment of the invention, machining a groove 50 on the upper face 5S (in the XY plane) of the sorting block 5 (FIG. 3) is provided for. This groove 50 preferably has a length (along the X axis) at least equal to the length of the curtain of jets 10. One end 500 of the groove 50 is placed at atmospheric pressure. This pressurisation may for example be achieved by extending the groove 500 up to a lateral edge of the sorting block 5 (FIG. 4).

Another zone 501 of the groove 50 is connected to a vacuum generated for example by bringing it into communication with a vacuum pump. According to an advantageous embodiment, the vacuum may be generated by bringing it into communication with another delimited air space, through the intermediary of a channel 51 forming a chimney that opens out firstly onto the groove 50 and secondly into another space 70 delimited between the jets recovery gutter and the lower face 5I of the block 5. Such depressurising makes it possible to benefit from the forced vacuum created, from the start of printing, in this other air space 70 delimited by said gutter 7. The vacuum thereby created generates a longitudinal flow of air along the X axis in the groove 50, longitudinal flow fed by a traversal flow along the Y axis from the air space 9. A drop of liquid trapped in the air space 9 or in the angle α formed between the drop generator 1 and the block 5 is thereby carried along in the groove 50 and transported into the vacuum pump or the gutter 7 along the path symbolised by the arrow 16 of FIG. 3.

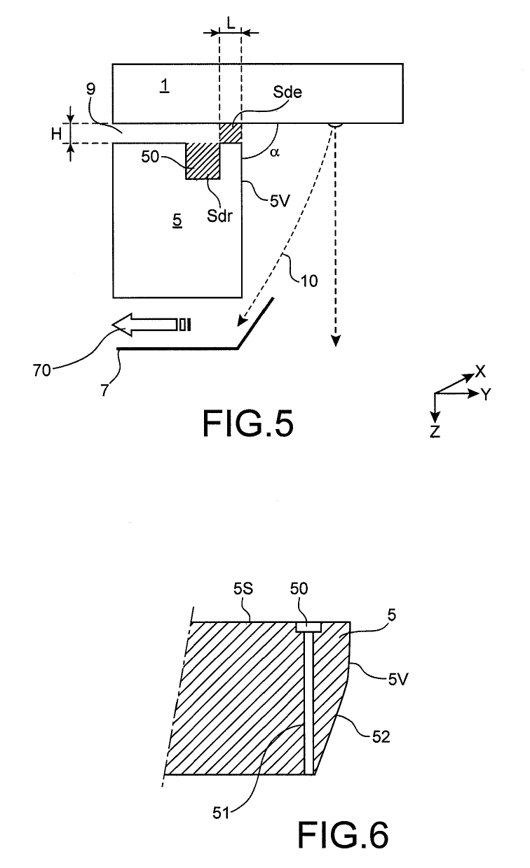

In the illustrated embodiment, the elements that make it possible to dimension the level of vacuum generated are the straight section Sdr of the groove 50, the straight section Sde delimited by the width L separating the groove 50 of the vertical wall 5V of the block of electrodes opposite the jets 10, the height H of the first air space 9 as well as the level of vacuum already achieved in the space 70 delimited by the gutter 7 and the lower face 5I of the block (FIG. 5). The straight section Sdr of the groove 50 is preferably the largest: thus, when a transversal flow component exists, the longitudinal velocity component must be significantly greater than the transversal component to produce a sufficient entrainment effect of the liquid.

In the embodiment illustrated, the vacuum source is around 0.6 bars (relative pressure), the transversal section of the groove in the XZ plane is around 1 mm² and the transversal section of the air space 9 in the XZ plane is around 0.1 mm².

According to a preferred alternative embodiment, when the sorting block 5 comprises, by construction, a bevel 52, the chimney 51 according to the invention is preferably formed as near as possible to this bevel 52, in other words by reducing to the maximum the communication length Lc between the chimney 51 and the rectilinear part of the groove 50 and while at the same time having the chimney 51 opening out directly onto the space 70 (FIG. 6).

According to another preferred alternative, the chimney 51 is machined in line with the end of the electrodes Elec (FIG. 4).

The invention that has just been described relates to the means of sucking up any stagnant liquid before the start up of printing.

It goes without saying that the means provided make it possible to suck up any stagnant liquid in the space between the sorting block (one-piece part in which are implanted the fixed electrodes in the embodiment illustrated) and the nozzle(s) plate for ejection of the ink, during the printing. In particular, the embodiment by forced vacuum created by the chimney and the space delimited by the recovery gutter makes it possible to suck up in a continuous manner as of the start of printing and while in operation any non desired stagnant liquid and to re-inject it into the ink recycling circuit via the gutter.

1. A liquid jet print head comprising:
a generator of drops of liquid in which a lower part comprises a plate equipped with at least one nozzle for ejecting the liquid;
a sorting block laid out below the nozzle plate and offset compared to the axis of the at least one nozzle, wherein the sorting block and the generator are fixed in relation to each other by delimiting a first space and by forming an angle α in a vertical plane; and
means for sucking up any stagnant liquid in the first space or in the angle before the ejection of liquid from the at least one nozzle at the start of printing, in which the suction means comprises at least one groove cut on the face of the sorting block opposite the nozzle plate while being opened out towards said plate, wherein a zone of the groove is placed at atmospheric pressure and another zone is placed at a lower pressure so as to suck up thereby any stagnant liquid towards the lower pressure zone during start up of printing.

2. The print head according to claim 1, in which the sorting block comprises a device comprising at least one electrode exercising an electrostatic action on one or several jets of liquid.

3. The print head according to claim 1, in which one end of the groove opens out at the end of the block at atmospheric pressure and in which the suction means comprises a suction pump linked to another zone of the groove, wherein a start up of operation of the suction pump at the start of printing sucks up any stagnant liquid.

4. The print head according to claim 2, in which the sorting block device comprising at least one electrode further comprises a liquid recovery gutter laid out at least in part below said at least one electrode while delimiting a second space and, in which the suction means comprises:
at least one channel forming a chimney cut in the block and opening out on either side onto the first and second spaces; and
the groove cut on the face of the sorting block of which one end opens out at the end of the sorting block, at atmospheric pressure, and in which a zone communicates with the chimney, wherein start up of the print head causes a suction in the second space in such a way that any stagnant liquid in the first space is sucked up into the groove then is pushed into the chimney by a forced vacuum to be collected and evacuated via the gutter.

5. The print head according to claim 4, in which the sorting block is matched with a bevel in a vertical plane between the first and the second space, wherein the chimney is cut as near as possible to the bevel in order to reduce a communication length between the chimney and the groove.

6. The print head according to claim 4, in which the groove is cut at a distance from an edge of the sorting block such that a straight section of the groove is greater than a straight section delimited by a height of the first space and said distance between the edge of the block and the groove.

7. The print head according to claim 1, comprising a multitude of aligned nozzles constructed to generate a curtain of jets, wherein electrodes are identical for all said jets and the chimney is positioned above one end of the electrodes.

8. The print head according to claim 1, wherein the sorting block device comprising at least one electrode further comprises at least one groove machined on one face of said device and adapted to be fixed below a nozzle plate of said print head.
